(19) United States
(12) Patent Application Publication
(10) Pub. No.: US 2024/0193706 A1
(43) Pub. Date: Jun. 13, 2024

(54) SYSTEM AND METHOD FOR DETERMINING INDOOR FARMING EFFICIENCY AND BENEFITS

(71) Applicant: N2 Made, LLC, Boulder, CO (US)

(72) Inventors: Holden Caine, Boulder, CO (US); Ali Seymen Ertas, Boulder, CO (US)

(21) Appl. No.: 18/513,128

(22) Filed: Nov. 17, 2023

Related U.S. Application Data
(60) Provisional application No. 63/386,456, filed on Dec. 7, 2022.

(51) Int. Cl. G06Q 50/02

(52) U.S. Cl. CPC G06Q 50/02

(57) ABSTRACT

Systems and methods determine indoor farming efficiency and benefits. A status report indicative of a crop being grown by the indoor farm is received by an efficiency and benefit calculator, which determines quantities of farm inputs to the indoor farm to grow the crop, and a quantity of produce expected at the end of the grow cycle of the crop. The efficiency and benefit calculator calculates traditional inputs to a traditional farm needed to grow an equivalent of the crop, and generating an efficiency and benefits report for the indoor farm based on differences between the inputs to the traditional farm and the quantities of farm inputs to the indoor farm. The efficiency and benefits report includes accurately estimated savings made by the indoor farm over traditional farming techniques such that the efficiency and benefits report is usable by an organization to determine compensation and/or incentives for the indoor farm.

### RELATED APPLICATION

This application claims priority to U.S. Patent Application No. 63/386,456, titled “System and Method for Determining Indoor Farming Efficiency and Benefits,” filed Dec. 7, 2022, and included herein by reference in its entirety.

### BACKGROUND

Indoor farming methods such as hydroponic, vertical, and greenhouse farms, have numerous benefits to society, such as less water use, minimal or no use of pesticides and other dangerous chemicals, less transportation to many areas where outdoor farming is not possible for at least part of the year, to name a few. Unfortunately, many of these benefits are difficult to quantify and monetize because they are secondary effects, requiring the indoor farmer to compete with large scale traditional farms in a highly competitive market based on produce price alone. Where an initial cost of the indoor farm equipment is high, there is no existing incentive to start new indoor farms.

### SUMMARY

One aspect of the present embodiments includes the realization that incentives that promote local, efficient indoor farming would provide numerous benefits to society, and that it is difficult to quantify, on a per product bases, the efficiencies and benefits provided by an indoor farm. The present embodiments solve this problem by providing a system and method that compares multiple factors (inputs and outputs) of the indoor farm to similar factors of traditional farming to estimate the efficiencies and benefits. Advantageously, by identifying and providing the efficiencies and benefits on a per farm basis to a compensation organization, the compensation organization can provide incentives (similar to other incentives in the energy industry) to the indoor farmer. The embodiments described herein provide systems and methods for quantifying and potentially monetizing these efficiencies and benefits by local state, and national, governments and/or other organizations having an overall long-term goal of improving food production efficiency and reducing the effects of farming on the environment.

In certain embodiments, the techniques described herein relate to a system for determining indoor farming efficiency and benefits, including: a processor; and memory storing machine-readable instructions that, when executed by the processor, cause the processor to: receive a status report indicative of a crop being grown by an indoor farm; determine quantities of farm inputs to the indoor farm to grow the crop based on received metered data; determine a quantity of produce expected at an end of a grow cycle of the crop based on the status report; calculate traditional inputs to a traditional farm to grow an equivalent quantity of produce; and generate an efficiency and benefits report for the indoor farm based on differences between the traditional inputs to the traditional farm and the quantities of the farm inputs to the indoor farm.

In certain embodiments, the techniques described herein relate to a method for determining indoor farming efficiency and benefits, including: receiving a status report indicative of a crop being grown by an indoor farm; determining quantities of farm inputs to the indoor farm to grow the crop based on received metered data; determining a quantity of produce expected at an end of a grow cycle of the crop based on the status report; calculating traditional inputs to a traditional farm to grow an equivalent quantity of produce; and generating an efficiency and benefits report for the indoor farm based on differences between the traditional inputs to the traditional farm and the quantities of the farm inputs to the indoor farm.

In certain embodiments, the techniques described herein relate to a software product including instructions, stored on computer-readable media, wherein the instructions, when executed by a computer, perform steps for determining indoor farming efficiency and benefits, including instructions for: receiving a status report indicative of a crop being grown by an indoor farm; determining quantities of farm inputs to the indoor farm to grow the crop based on received metered data; determining a quantity of produce expected at an end of a grow cycle of the crop based on the status report; calculating traditional inputs to a traditional farm to grow an equivalent quantity of produce; and generating an efficiency and benefits report for the indoor farm based on differences between the traditional inputs to the traditional farm and the quantities of farm inputs to the indoor farm.

### BRIEF DESCRIPTION OF THE FIGURES

FIG. 1 is a block diagram showing one example system for determining indoor farming efficiency and benefits, in embodiments.

FIG. 2 is a block diagram showing efficiency and benefit calculator of FIG. 1 in further example detail, in embodiments.

FIG. 3 is a block diagram showing conversion constants of FIG. 1 in further example detail including a water usage table and a grow cycle for one geographic area and one plant type, in embodiments.

FIG. 4 is a data flow diagram illustrating one example calculation method implemented by water algorithm of FIG. 2 for determining water savings for crop, in embodiments.

FIG. 5 is a flowchart illustrating one example method for determining efficiency and benefits of an indoor farm, in embodiments.

FIG. 6 is a block diagram showing efficiency and benefit calculator providing a service for multiple indoor farms located in certain geographic areas, in embodiments.

### DETAILED DESCRIPTION OF THE EMBODIMENTS

Indoor farming that controls characteristics (lighting, heating, cooling, etc.) of an indoor growing environment is generally much more energy intensive than a traditional (outdoor) farming, that uses a natural environment where certain energy (e.g., sunlight) is free. That is, energy cost for the indoor farm is typically higher than energy cost for the traditional farm. Accordingly, the following systems and methods monitor energy as part of tracking the cost of operating the indoor farm as opposed to looking for energy efficiency over the traditional farm. However, by monitoring these differences, the systems and methods may provide useful data to minimize and optimize energy usage on the indoor farm. Further, the systems and methods determine other efficiencies and benefits of the indoor farm that outweigh the higher energy costs and thereby indicate an overall efficiency of the indoor farm. Energy is an expense for an indoor farm, just as fuel to run planting and harvesting equipment is an expense for a traditional farm. The systems and methods herein do not compare energy and fuel expended for normal operating of the farm but do compare fuel used for delivery of produce.

Particularly, the systems and methods described herein also calculate secondary environmental and other benefits, such as reduced environmental impact and transportation costs of the indoor farm. By determining these benefits, a compensation organization may provide the indoor farm up-front subsidies, monthly, annual and/or volume based credits, tax incentives and/or other means of incentive and/or compensation.

For the following description, it should be noted that a grow cycle for a plan on a traditional farm is typically longer than a grow cycle for the same plant grown on an indoor farm. Accordingly, the described benefits and efficiencies are calculated on a daily basis and adjusted for the total number of days in the grow cycle for both the traditional farm and the indoor farm. For example, an average amount of water used per day on a traditional farm may be less than the average amount of water used per day on an indoor farm, however, since the grow cycle for the traditional farm is longer, more water is required on the traditional farm for the plants to reach maturity.

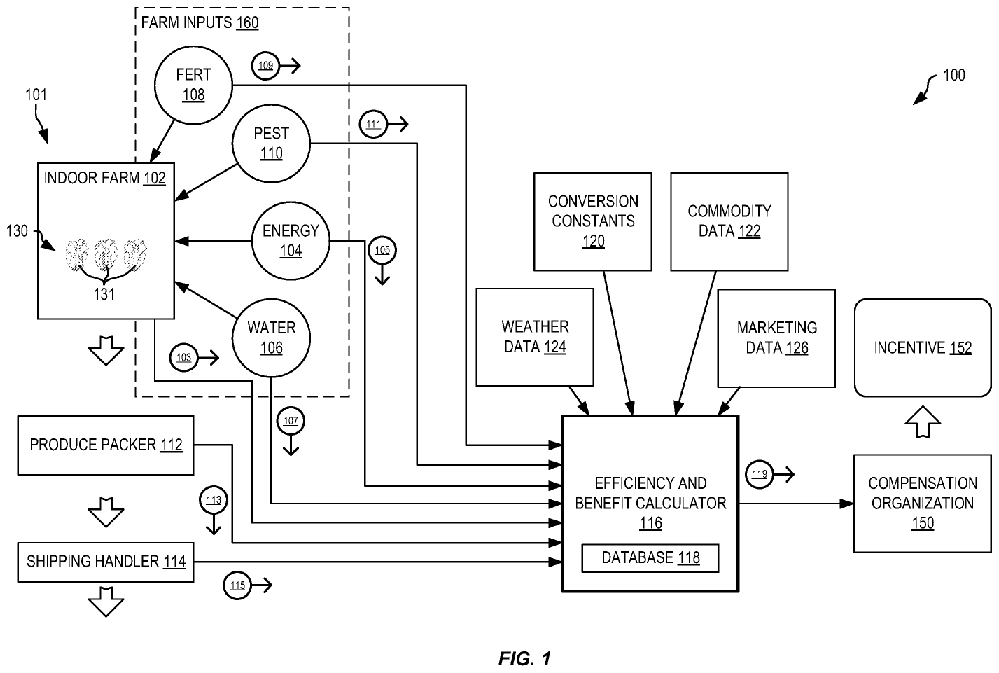

FIG. 1 is a block diagram showing one example system 100 for determining indoor farming efficiency and benefits. An indoor farm 102 may represent any one or more of a hydroponic farm, a vertical farm, and a greenhouse farm, that grows one, or more, crops 130 of a particular type of plant 131. For example, a first crop 130 may have lettuce plants 131, and a second crop 130 may have radish plants 131. Indoor farm 102 may be fully automated. For example, indoor farm 102 may autonomously provide a nutrient solution in which crop 130 grows and may autonomously monitor growth of plants 131 throughout their grow cycle. To grow crop 130, indoor farm 102 uses a plurality of growing inputs 160 including energy 104, water 106, fertilizer 108, and optionally pesticides 110, each of which is measured.

To simplify discussion herein, indoor farm 102 is shown with a single crop 130. However, indoor farm 102 may simultaneously grow multiple crops 130, where each crop 130 is evaluated as described herein. Crop 130 is a group of plants 131 of the same plant type (e.g., lettuce) that are started at the same time and collectively handles together. In one operational example, indoor farm 102 grows multiple crops 130 of the same plant type that were started at different dates. In another operational example, indoor farm 102 grows multiple crops 130, where each crop is of a different plant type and different grow cycle. For example, a first crop 130 of lettuce is started at a first date and a second crop 130 of lettuce is started part way through the grow cycle of the first crop, such that each crops harvest at a different date. In another example, indoor farm starts a first crop of lettuce and a second crop of radishes at the same start date where the first crop and the second crop have different grow cycles. Thus, indoor farm 102 may adjust crop planning to meet expected market demands.

System 100 includes an efficiency and benefit calculator 116 that receives operational information of indoor farm 102 and generates an efficiency and benefits report 119 for indoor farm 102 that is indicative of its estimated efficiency and benefit as compared to traditional farming techniques and practices used to grow the same plants or produce. Efficiency and benefit calculator 116 is a digital computer (e.g., a server, a networked group of servers, etc.) that includes software and data that implements the functionality described herein. In certain embodiments, efficiency and benefit calculator 116 is implemented by an online cloud-based service.

During operation of indoor farm 102, energy 104, water 106, fertilizer 108, and pesticides 110 are metered for crop 130 and reported to efficiency and benefit calculator 116 as energy data 105, water data 107, fertilizer data 109 and pesticide data 111. At intervals (e.g., hourly, daily, etc.), indoor farm 102 sends a status report 103 to efficiency and benefit calculator 116. Status report 103 identifies indoor farm 102 and provides a status of crop 130. In one example, status report 103 indicates a future start date, a type of plant 131, and a quantity of plants 131 in an intended crop 130. In another example, status report 103 indicates a start date, a type of plant 131, and a quantity of plants 131 in crop 130. In another example, indoor farm 102 sends status report 103 indicating a stage of the grow cycle (e.g., 50% of a three-week growing period) and measured growth or size of plants 131 in each crop 130.

When crop 130 reaches maturity, indoor farm 102 harvests crop 130 and a produce packer 112 (e.g., where harvested plants 131 are packed in preparation for sale/shipping) quantifies the harvested crop 130 and sends a produce quantity report 113 to efficiency and benefit calculator 116 indicating a quantity (e.g., weight, units, etc.) of the harvested crop 130. A shipping handler 114 (e.g., where packed crop 130 is loaded onto vehicles for transport to a buyer) sends a shipping report 115 to efficiency and benefit calculator 116 indicating one or more of a destination location (e.g., address and/or geographic coordinates) and a shipping fuel cost.

Efficiency and benefit calculator 116 may include a database 118 for storing received status reports 103, received metered data (e.g., energy data 105, water data 107, fertilizer data 109, pesticide data 111), produce quantity reports 113, and shipping reports 115 in association with indoor farm 102 (e.g., using a unique identifier) and other pertinent information about indoor farm 102, such as one or more of an address of indoor farm 102, a geographic area 101 or location of indoor farm 102, contact information of indoor farm 102, and so on. In certain embodiments, efficiency and benefit calculator 116 includes a simulation mode that allows a user to estimate benefits before building an indoor farm, thereby allowing benefits to be paid up front as an incentive and also may provide recommendations on crop selection for a better return on investment (ROI) for the indoor farm.

Efficiency and benefit calculator 116 processes received status reports 103, energy data 105, water data 107, fertilizer data 109, pesticide data 111, produce quantity reports 113, and shipping reports 115 using one or more of conversion constants 120, commodity data 122, weather data 124, and marketing data 126, to generate efficiency and benefits report 119. In certain embodiments, conversion constants 120 and commodity data 122 is stored in database 118. In other embodiments, conversion constants 120 and commodity data 122 is received via an Application Programming Interface (API) from a third party. Conversion constants 120 define performance factors for traditional farming for different geographic areas and different types of plant 131 and are dependent on location and time of year. Commodity data 122 defines a current or seasonal costs of energy, water, fertilizer, pesticide, and fuel based on location (e.g., data for different geographic areas). Conversion constants 120 and commodity data 122 are derived empirically and documented to allow independent verification. For example, an additional service or third party may determine and provide appropriate parameters for conversion constants 120 and commodity data 122. This would allow a compensation organization 150 to have assurances that calculations performed by efficiency and benefit calculator 116 are objective. Advantageously, where the third party provides current data from a traditional farm (e.g., instead of constants), accurate of benefit calculations provided by efficiency and benefit calculator 116 is more accurate. Weather data 124 defines weather conditions for each geographic area and historical weather data (e.g., averages) for each geographic area. Marketing data 126 defines produce prices and market needs for different geographic areas. Commodity data 122, weather data 124, and marketing data 126 may be sourced from one or more third parties.

Efficiency and benefit calculator 116 sends efficiency and benefits report 119 to a compensation organization 150 (e.g., a government organization, a local benefit group, etc.) that provides an incentive 152 (e.g., money, tax credits, etc.) to indoor farm 102 based on the estimated efficiency and benefits of indoor farm 102 over traditional farming. Efficiency and benefits report 119 may indicate one or more of water savings 252, fertilizer savings 254, pesticide savings 256, and fuel savings 258 that are attributed to indoor farm 102 based on its reported inputs and estimated (or actual if crop 130 has been harvested) output and based on its geographic location. Accordingly, efficiency and benefits report 119 further indicates environmental benefits of indoor farm 102 over traditional farming, such as reduced water use based on water savings 252, reduced pesticide use based on pesticide savings 256 indicating less harm to the environment, reduced fertilizer use based on fertilizer savings indicating less runoff/pollution from fertilizer, and reduced fuel for produce delivery based on fuel savings 258 that result in less air pollution and reduced traffic etc.

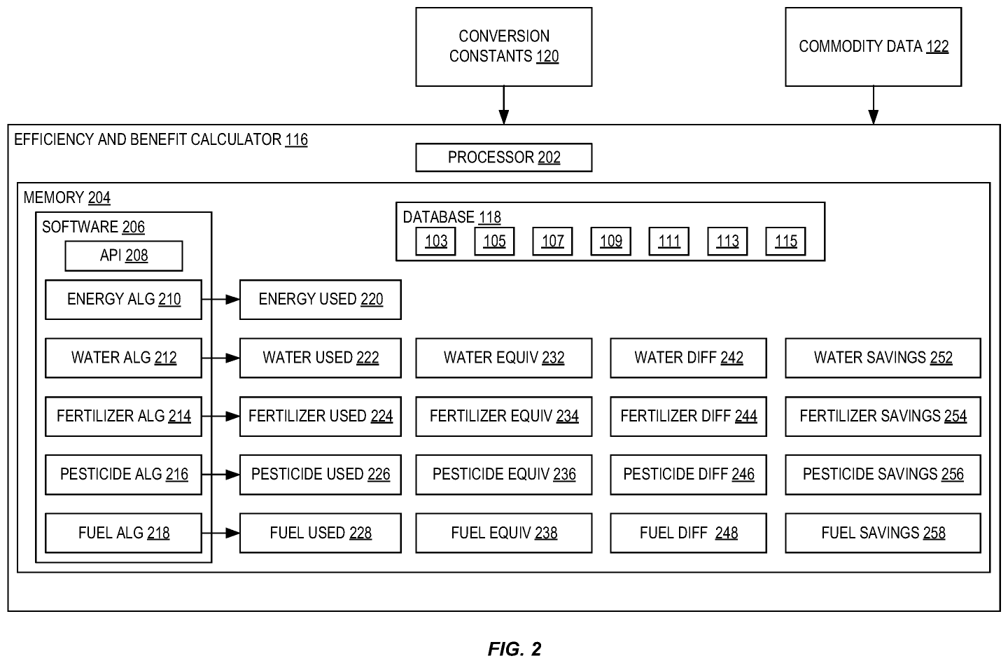

FIG. 2 is a block diagram showing efficiency and benefit calculator 116 of FIG. 1 in further example detail. Efficiency and benefit calculator 116 includes a processor 202 and memory 204 storing software 206 (e.g., software product having machine-readable instructions, stored on computer-readable media) that, when executed by processor 202, cause efficiency and benefit calculator 116 to implement functionality described herein. Software 206 may implement an API 208 for receiving status reports 103, energy data 105, water data 107, fertilizer data 109, pesticide data 111, produce quantity report 113, and shipping report 115. As shown, database 118 may be implemented within memory 204. However, in certain embodiments, database 118 may be implemented external to efficiency and benefit calculator 116 and accessed via a computer network.

Software 206 includes an energy algorithm 210 that processes status reports 103, produce quantity report 113, and energy data 105 to determine an energy used 220 to grow crop 130. For example, energy algorithm 210 may calculate energy usage per plant 131 per day, then determine the total energy used to grow each plant 131 by summing the energy used each day for the grow cycle of each plant 131. Energy used 220 may be used help improve efficiency usage of indoor farm 102, but is not used for comparison with the energy used to grow the equivalent plant on a traditional farm.

Efficiency and benefit calculator 116 includes a water algorithm 212 that processes status reports 103, produce quantity report 113, and water data 107 using conversion constants 120 to determine a water used 222 per plant 131 (or per unit of weight of plants 131 in crop 130). Water algorithm 212 also determines a water equivalent 232 that estimates an amount of water that would be used in a traditional farm to grow crop 130 and generates a water difference 242 that represents a difference between water used 222 and water equivalent 232. Water savings 252 may be determined from water difference 242 and a local water cost.

Efficiency and benefit calculator 116 includes a fertilizer algorithm 214 that processes status reports 103, produce quantity report 113, and fertilizer data 109 using conversion constants 120 to determine a fertilizer used 224 per plant 131 of crop 130. Fertilizer algorithm 214 also determines a fertilizer equivalent 234 that estimates an amount of fertilizer that would be used in a traditional farm to grow crop 130 and generates a fertilizer difference 244 that represents a difference between fertilizer used 224 and fertilizer equivalent 234. Fertilizer savings 254 may be determined from fertilizer difference 244 and a fertilizer cost.

Efficiency and benefit calculator 116 includes a pesticide algorithm 216 that processes status reports 103, produce quantity report 113, and pesticide data 111 using conversion constants 120 to determine a pesticide used 226 per crop 130. Pesticide algorithm 216 also determines a pesticide equivalent 236 that estimates an amount of pesticide that would be used in a traditional farm to grow crop 130 and generates a pesticide difference 246 that represents a difference between pesticide used 226 and pesticide equivalent 236. Pesticide savings 256 may be determined from pesticide difference 246 and a pesticide cost.

Efficiency and benefit calculator 116 includes a fuel algorithm 218 that processes status reports 103, produce quantity report 113, and shipping report 115 using conversion constants 120 to determine a fuel used 228 per crop 130. Fuel algorithm 218 also determines a fuel equivalent 238 that estimates an amount of fuel that would be used in a traditional farm to distribute crop 130 and generates a fuel difference 248 that represents a difference between fuel used 228 and fuel equivalent 238. Fuel savings 258 may be determined from fuel difference 248 and a fuel cost.

In certain embodiments, where efficiency and benefits report 119 was generated prior to harvesting of crop 130 such that produce quantity report 113 was estimated, when produce quantity report 113 is received based on harvesting of crop 130, software 206 may determine a different between the estimated harvest and the actual harvest and update efficiency and benefits report 119 accordingly.

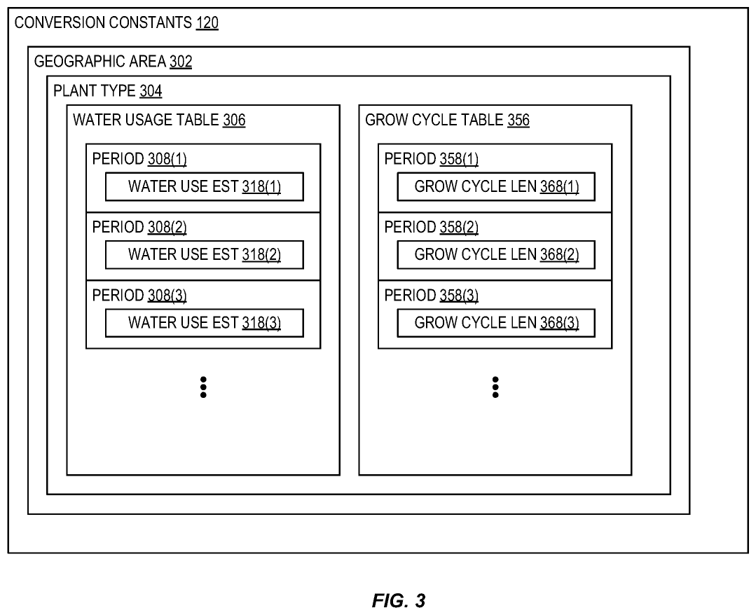

FIG. 3 is a block diagram showing conversion constants 120 of FIG. 1 in further example detail including a water usage table 306 and a grow cycle 356 for one geographic area 302 and one plant type 304. There are many variables associated with traditional farming that vary for different geographic areas and for different plant types and for different times of the year. Conversion constants 120 quantify and reduce these many variables to simple constants or functions that approximate the actual values. Conversion constants 120 define water use, fertilizer use, and pesticide use for at least one geographic area for at least one produce type during different periods of the year. Conversion constants 120 include multiple tables covering multiple geographic areas and multiple plant types, that define estimated constants (e.g., determined empirically) that allow traditional farming equivalent inputs to be estimated for a crop similar to crop 130 of indoor farm 102. For clarity of illustration, the following examples illustrate a water usage table 306 defining water consumption during each month of the year at geographic area 101 where plant 131 is lettuce. Other data and table structures may be used without departing from the scope hereof.

As shown in FIG. 3, for geographic area 302 (e.g., geographic area 101 of indoor farm 102) and for plant type 304 (e.g., lettuce), conversion constants 120 includes water usage table 306 and grow cycle 356. Water usage table 306 defines, for different period 308 of the year (e.g., days, weeks, months, season, quarters, etc.), a water use estimate 318 that represents how much water is used per day in geographic area 302 to grow one plant of plant type 304. For example, water use estimate 318 may define a quantity of water required per unit of weight of plants produced for each day of the plant's grow cycle, defined by grow cycle length 368. That is, water usage table 306 and grow cycle length 368 define an amount of water required on a traditional farm in the geographic area to grow the same plants as in crop 130. When there are no traditional farms near indoor farm 102, or when a local traditional farm is unable to grow plants 131, conversion constants 120 are provided for a non-local traditional farm that typically grows plants 131. Accordingly, the benefit of not having to ship the crop becomes more significant for indoor farm 102 when the plants cannot be grown locally on traditional farms. Grow cycle 356 defines a length (e.g., in days) of the grow cycle for plant type 304 on the traditional farm in geographic area 302 for different periods 358 (e.g., days, weeks, months, seasons, quarters, etc.) of the year. For example, the amount of water required and the length of the grow cycle for lettuce grown on a traditional farm varies by geographic area and the time of year. Advantageously, conversion constants 120 allow efficiency and benefit calculator 116 to determine an accurate comparison for any plant type of crop 130 for any geographic area 101.

The following example calculation illustrates operational water savings that are adjusted for a shorter indoor farm grow cycle. Let Wₜ(d) represent traditional farm water use per plant per day and Wᵢ(d) represent indoor farm water use per plant per day. Let Dₚₗₐₙₜ represent a date that a seed is planted at indoor farm 102 and Dₕₐᵣᵥₑₛₜ represent a date that the plant is harvested at indoor farm 102, where Dᵢ=Dₕₐᵣᵥₑₛₜ−Dₚₗₐₙₜ+1. Dₜ represents a number of days between seed and harvest for a traditional farm. The following equation calculates water savings by the indoor farm as compared to the traditional farm by adjusting for the longer grow cycle of the traditional farm.

$$Water Savings = {\sum }_{{D}_{harvest}}^{{D}_{plant}} {W}_{t} ( d ) * \frac{{D}_{t}}{{D}_{i}} - {\sum }_{{D}_{harvest}}^{{D}_{plant}} {W}_{i} ( d )$$

Conversion constants 120 includes similar tables defining corresponding values for each of fertilizer, and pesticide. As noted above, energy is an expense for an indoor farm, just as fuel to run planting and harvesting equipment is an expense for a traditional farm. Accordingly, efficiency and benefit calculator 116 does not directly compare energy usage of indoor farm 102 with fuel used for operation of a traditional farm because they're normal operating expenses.

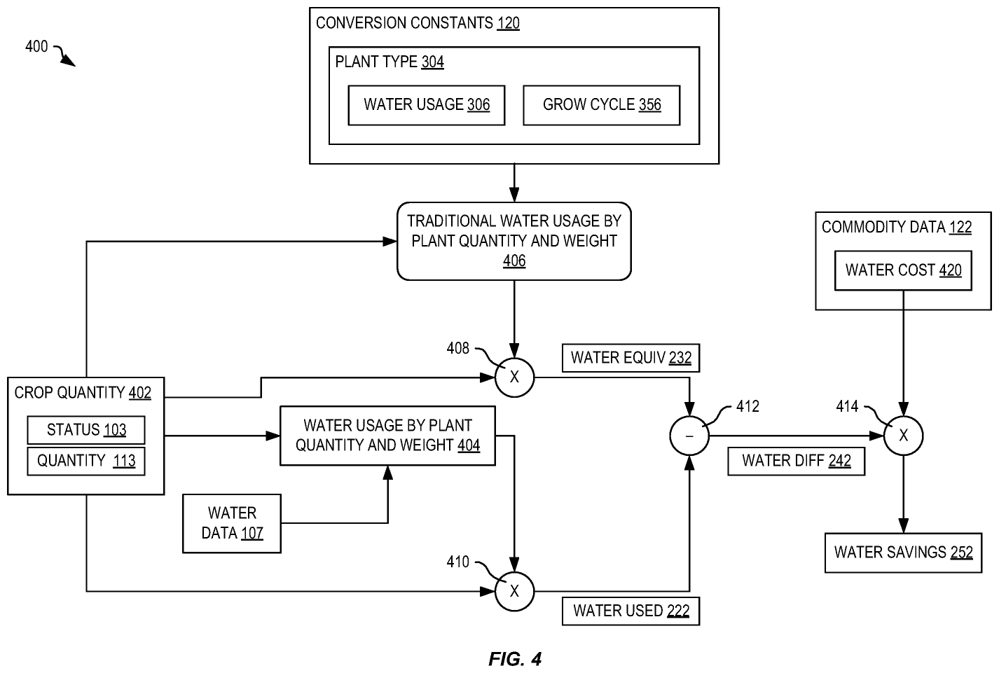

FIG. 4 is a data flow diagram illustrating one example calculation method 400 implemented by water algorithm 212 of FIG. 2 for determining water savings 252 for crop 130. Water algorithm 212 determines a crop quantity 402 based on one or both of an expected crop size within status report 103 (e.g., an expected quantity of plants and weight of plants) and/or a harvested quantity (e.g., quantity and weight of plants 131 received in produce quantity report 113). Crop quantity 402 may define a number of plants 131, an average weight of each plant 131, and/or a weight of crop 130. Thus, crop quantity 402 quantifies an expected crop 130 and/or a harvested crop 130.

Water algorithm 212 determines a crop quantity 402 indicative of a number and/or weight of plants 131 in crop 130 as received in status report 103. Water algorithm 212 also processes water data 107, received each day and stored in database 118 for example, to determine a water usage per plant by weight 404 for the complete grow cycle of crop 130. That is, water usage per plant by weight 404 defines the amount of water required to grow each plant 131 to a given harvest weight. For geographic area 302 and plant type 304 corresponding to indoor farm 102 and crop 130, water algorithm 212 interpolates a water use estimate 318 of water usage table 306 for the corresponding geographic area and time of year and grow cycle 356 to determine a traditional water usage per plant quantity and weight 406. Traditional water usage per plant quantity and weight 406 is therefore an accurate estimate of the amount of water required to grow the plant on a conventional farm in the same area at the same time of year. Grow cycle 356 defines an expected grow cycle for the plants on a traditional farm in that area at the current time of year. The grow cycle of a plant may change on a traditional farm because the environment (e.g., amount of sun, weather, etc.) changes throughout the year. Efficiency and benefit calculator 116 integrates/interpolates the water use estimate 318 over a corresponding grow cycle length 368 to calculate water equivalent 232, which is thus an estimate of water needed to grow crop 130 (e.g., the same quantity of plants) on the traditional farm. In certain embodiments, water algorithm 212 also uses live weather data 124 to adjust water equivalent 232 for extremes of weather in geographic area 101. For example, an unusually dry spring would require additional watering on a traditional farm to replace missed rainfall.

Traditional water usage per plant quantity and weight 406 is multiplied 408 by crop quantity 402 to determine water equivalent 232 that estimates the quantity of water used by the traditional farm to grow an equivalent of crop 130. Water algorithm 212 also multiplies 410 water usage per plant by weight 404 by crop quantity 402 to determine water used 222 by indoor farm 102 to grow crop 130. Water algorithm 212 then subtracts 412 water used 222 from water equivalent 232 to determine water difference 242 that estimates the amount of water saved by indoor farm 102 as compared to the traditional farm. Water algorithm 212 may then estimate water savings 252 by multiplying 414 water difference 242 by a local water cost 420 from commodity data 122.

Efficiency and benefit calculator 116 uses similar techniques to determine fertilizer savings 254, pesticide savings 256, and fuel savings 258. Advantageously, efficiency and benefit calculator 116 uses conversion constants 120 and commodity data 122 to estimate one or more of water savings 252, fertilizer savings 254, pesticide savings 256, and fuel savings 258 made by indoor farm 102 over the traditional farm to grow crop 130. Accordingly, efficiency and benefits report 119 estimates traditional quantities for each of the traditional inputs to a traditional farm to grow the equivalent of the crop grown by indoor farm 102.

Efficiency and benefit calculator 116 generates efficiency and benefits report 119 indicating one or more of water savings 252, fertilizer savings 254, pesticide savings 256, and fuel savings 258 and may submit efficiency and benefits report 119 to an organization that compensates indoor farm 102 for these savings and/or benefits (e.g., benefits to the environment through reduced water usage, reduced fertilizer use, reduced pesticide use, and reduced fuel use).

Further, efficiency and benefit calculator 116 determines fuel savings 258 based on differences in transportation costs for crop 130 as compared to transportation costs for a traditional farm. For example, indoor farm 102 may be positioned more local to destinations (e.g., consumers) of crop 130 as compared to traditional farms that are more likely further from the consumers and therefore require further transportation. That is, efficiency and benefit calculator 116 determines a fuel saving based on (a) a first transportation distance between the indoor farm and a location of a consumer of the crop and (b) a second transportation distance between a nearest traditional farm and the location of the consumer. Advantageously, by determining fuel savings 258, efficiency and benefit calculator 116 shows the benefits of positioning indoor farm 102 closer to consumers (e.g., produce destination) as compared to traditional farms that are typically located more remote from consumer centers. Thus, although energy used to grow indoor crops is likely a much higher cost than the energy used to run a traditional farm, the fuel savings by delivering produce locally may offset the higher energy cost incurred by indoor farm 102.

By generating efficiency and benefits report 119, the organization that compensates indoor farm 102 for these savings and/or benefits. In certain situations, such as for a newly contemplated indoor farm, efficiency and benefit calculator 116 may allow the organization to provide incentives for establishing the indoor farm. Efficiency and benefits report 119 provides a best-estimate comparison between indoor farming and traditional farming that considers key factors that affect both the efficiency of growing crops, the effects of farming on the local environment, and the efficiencies of being local to consumers, to provide compensation and incentives to promote efficient indoor farming, allowing the industry to scale to the point where it may have a significant impact on how resources are used for food production. Accordingly, efficiency and benefits report 119 includes accurately estimated savings made by indoor farm 102 over traditional farming techniques such that efficiency and benefits report 119 is usable by an organization to determine compensation and/or incentives for indoor farm 102.

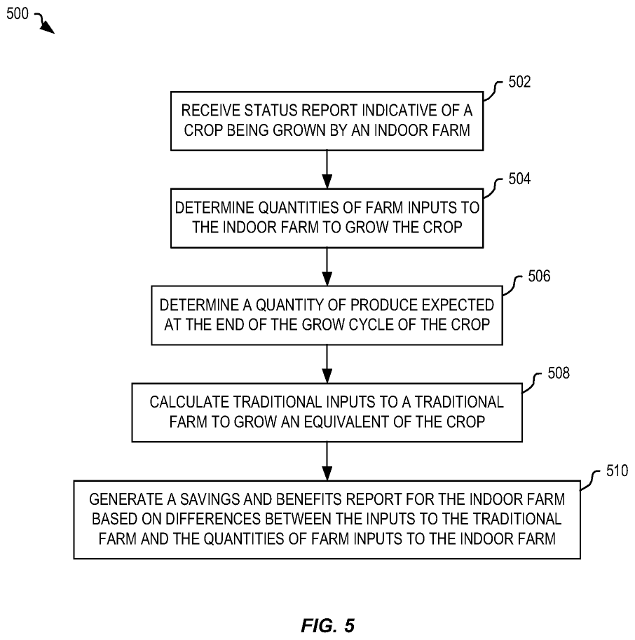

FIG. 5 is a flowchart illustrating one example method 500 for determining efficiency and benefits of an indoor farm. Method 500 is implemented by efficiency and benefit calculator 116 of FIG. 1, for example.

In block 502, method 500 receives a status report indicative of a crop being grown by the indoor farm. In one example of block 502, efficiency and benefit calculator 116 receives status report 103 with quantity and plant type information of crop 130 from indoor farm 102.

In block 504, method 500 determines quantities of farm inputs to the indoor farm to grow the crop. In one example of block 504, efficiency and benefit calculator 116 receives energy data 105, water data 107, fertilizer data 109 and pesticide data 111 corresponding to crop 130.

In block 506, method 500 determines a quantity of produce expected at the end of the grow cycle of the crop. In one example of block 506, efficiency and benefit calculator 116 estimates crop quantity 402 based on status report 103 and optionally using historical data for indoor farm 102. In another example of block 506, at harvest time of crop 130, efficiency and benefit calculator 116 determines crop quantity 402 based on a received produce quantity reports 113 from produce packer 112.

In block 508, method 500 calculates traditional inputs to a traditional farm to grow an equivalent of the crop. In one example of block 508, efficiency and benefit calculator 116 uses conversion constants 120 to calculate each of water equivalent 232, fertilizer equivalent 234, and pesticide equivalent 236 for growing the same plant type on a convention farm in the same geographic location.

In block 510, method 500 generates an efficiency and benefits report for the indoor farm based on differences between the inputs to the traditional farm and the quantities of farm inputs to the indoor farm. In one example of block 510, efficiency and benefit calculator 116 calculates water savings 252, fertilizer savings 254, and pesticide savings 256, based on differences between water used 222, fertilizer used 224 and pesticide used 226 and water equivalent 232, fertilizer equivalent 234, and pesticide equivalent 236, respectively, for inclusion in generated efficiency and benefits report 119.

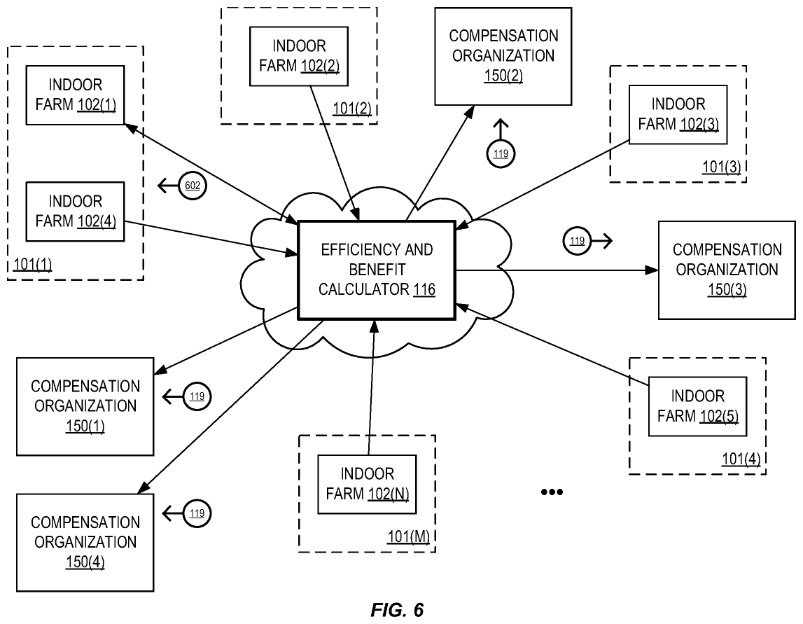

FIG. 6 is a block diagram showing efficiency and benefit calculator 116 providing a service for multiple indoor farms 102(1)-(N) located in certain geographic areas 101(1)-(N). In this example, indoor farms 102(1) and 102(4) are located in geographic area 101(1), indoor farm 102(2) is located in geographic area 101(2), indoor farm 102(3) is located in geographic area 101(3), indoor farm 102(5) is located in geographic area 101(4), and indoor farm 102(N) is located in geographic area 101(M).

Efficiency and benefit calculator 116 is a central monitoring point for each indoor farm 102 and thereby may provide useful feedback to indoor farms 102 based on information learned from others of the indoor farms. For example, efficiency and benefit calculator 116 uses marketing data 126 to learn of demands in the current or future local markets for different plant types in geographic area 101(1) and based on status reports 103 from indoor farms 102(1) and 102(4) may determine where currently growing crops 130 are not predicted to meet the market demands. Advantageously, efficiency and benefit calculator 116 may indicate which plant type indoor farms 102(1) and (4) should plant in subsequent crops to meet the demands. Efficiency and benefit calculator 116 may also indicate where indoor farms 102(1) and 102(4) are growing too much of the same plant type for the expected market in geographic area 101(1).

Efficiency and benefit calculator 116 may operate with multiple compensation organizations 150. For example, compensation organization 150(1) may operate within geographic area 101(1), compensation organization 150(2) may operate within geographic area 101(2), and compensation organization 150(3) may operate within geographic area 101(3). Alternatively, or as well, compensation organization 150(4) may operate for multiple geographic areas 101.

In certain embodiments, efficiency and benefit calculator 116 may also generate a performance report 602 for each indoor farm 102 that indicates a performance on the indoor farm in comparison to other indoor farms 102. For example, the performance report may give a ranking of the indoor farm's efficiency and saving as compared to the other indoor farms in the same geographic area 101. Advantageously, indoor farm 102 receives feedback on its performance as compares to other indoor farms.

In certain embodiments, where efficiency and benefit calculator 116 receives additional information from indoor farm 102, such as temperature, lighting conditions, plant growth measurements, camera feeds, chemical analysis, and so on, within status report 103 for example, efficiency and benefit calculator 116 may generate a more detailed performance comparison with other indoor farms growing similar crops. Efficiency and benefit calculator 116 may implement one or more artificial intelligence (AI) algorithms and tools that collectively monitor and compare received information to determine optimal growing conditions for each plant type at each stage of its grow cycle. Advantageously, the optimal growing conditions may be shared with each indoor farm to automatically improve efficiency and benefits produced therefrom.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A system for determining indoor farming efficiency and benefits, comprising:
a processor; and
memory storing machine-readable instructions that, when executed by the processor, cause the processor to:
receive a status report indicative of a crop being grown by an indoor farm;
determine quantities of farm inputs to the indoor farm to grow the crop based on received metered data;
determine a quantity of produce expected at an end of a grow cycle of the crop based on the status report;
calculate traditional inputs to a traditional farm to grow an equivalent quantity of produce; and
generate an efficiency and benefits report for the indoor farm based on differences between the traditional inputs to the traditional farm and the quantities of the farm inputs to the indoor farm.

2. The system of claim 1, further comprising an application programming interface for receiving the status report and the quantities of the farm inputs.

3. The system of claim 1, the farm inputs comprising at least two of: water data indicative of water used by the indoor farm, fertilizer data indicative of fertilizer used by the indoor farm, and pesticide data indicative of pesticide used by the indoor farm.

4. The system of claim 1, the memory further storing machine-readable instructions that, when executed by the processor, cause the processor to interpolate conversion constants based on geographic location, plant type, grow cycle, and time of year to determine traditional quantities for each of the traditional inputs to the traditional farm to grow the equivalent of the crop.

5. The system of claim 1, wherein the efficiency and benefits report includes accurately estimated savings made by the indoor farm over traditional farming techniques such that the efficiency and benefits report is usable by an organization to determine compensation and/or incentives for the indoor farm.

6. The system of claim 1, the memory further storing machine-readable instructions that, when executed by the processor, cause the processor to determine a fuel saving based on (a) a first transportation distance between the indoor farm and a location of a consumer of the crop and (b) a second transportation distance between a nearest traditional farm and the location of the consumer.

7. The system of claim 6, wherein the fuel saving is included in the efficiency and benefits report.

8. A method for determining indoor farming efficiency and benefits, comprising:
receiving a status report indicative of a crop being grown by an indoor farm;
determining quantities of farm inputs to the indoor farm to grow the crop based on received metered data;
determining a quantity of produce expected at an end of a grow cycle of the crop based on the status report;
calculating traditional inputs to a traditional farm to grow an equivalent quantity of produce; and
generating an efficiency and benefits report for the indoor farm based on differences between the traditional inputs to the traditional farm and the quantities of the farm inputs to the indoor farm.

9. The method of claim 8, wherein the efficiency and benefits report includes accurately estimated savings made by the indoor farm over traditional farming techniques such that the efficiency and benefits report is usable by an organization to determine compensation and/or incentives for the indoor farm.

10. The method of claim 8, the farm inputs including at least two of water data indicative of water used by the indoor farm, fertilizer data indicative of fertilizer used by the indoor farm, and pesticide data indicative of pesticide used by the indoor farm.

11. The method of claim 8, the calculating traditional inputs comprising interpolating conversion constants based on geographic location, plant type, grow cycle, and time of year to determine traditional quantities for each of the traditional inputs to the traditional farm to grow the equivalent of the crop.

12. The method of claim 8, further comprising determining a fuel saving based on (a) a first transportation distance between the indoor farm and a location of a consumer of the crop and (b) a second transportation distance between a nearest traditional farm and the location of the consumer.

13. The method of claim 12, further comprising including the fuel saving in the efficiency and benefits report.

14. A software product comprising instructions, stored on computer-readable media, wherein the instructions, when executed by a computer, perform steps for determining indoor farming efficiency and benefits, comprising instructions for:
receiving a status report indicative of a crop being grown by an indoor farm;
determining quantities of farm inputs to the indoor farm to grow the crop based on received metered data;
determining a quantity of produce expected at an end of a grow cycle of the crop based on the status report;
calculating traditional inputs to a traditional farm to grow an equivalent quantity of produce; and
generating an efficiency and benefits report for the indoor farm based on differences between the traditional inputs to the traditional farm and the quantities of farm inputs to the indoor farm.

15. The software product of claim 14, wherein the efficiency and benefits report includes accurately estimated savings made by the indoor farm over traditional farming techniques such that the efficiency and benefits report is usable by an organization to determine compensation and/or incentives for the indoor farm.

16. The software product of claim 14, the farm inputs including water data indicative of water used by the indoor farm, fertilizer data indicative of fertilizer used by the indoor farm, and pesticide data indicative of pesticide used by the indoor farm.

17. The software product of claim 14, the calculating traditional inputs comprising interpolating conversion constants based on geographic location, plant type, grow cycle, and time of year to determine traditional quantities for each of the traditional inputs to the traditional farm to grow the equivalent of the crop.

18. The software product of claim 14, further comprising determining a fuel saving based on (a) a first transportation distance between the indoor farm and a location of a consumer of the crop and (b) a second transportation distance between a nearest traditional farm and the location of the consumer.

19. The software product of claim 18, further comprising including the fuel saving in the efficiency and benefits report.
